(19) United States
(12) Patent Application Publication
(10) Pub. No.: US 2008/0151080 A1
(43) Pub. Date: Jun. 26, 2008

(54) IMAGE PROCESSING DEVICE

(76) Inventors: Naoto Osaka, Shiga (JP); Hisao Kunitani, Kyoto (JP); Tatuo Itoman, Osaka (JP)

Correspondence Address: MCDERMOTT WILL & EMERY LLP, 600 13TH STREET, NW, WASHINGTON, DC, 20005-3096, US

(21) Appl. No.: 11/963,178

(22) Filed: Dec. 21, 2007

(30) Foreign Application Priority Data
Dec. 22, 2006 (JP) 2006-345770

(51) Int. Cl. H04N 5/217

(52) U.S. Cl. 348/241; 348/E05.078

(57) ABSTRACT

A noise shaping processing part performs noise shaping processing on pixel data. An adding circuit performs accumulative adding processing on the noise-shaped pixel data. A first bit-shift part performs bit-shift processing on the accumulatively-added and noise-shaped pixel data. A second bit-shift part performs bit-shift processing on unprocessed pixel data. An inter-pixel subtracting circuit calculates a gradation level difference between neighboring current pixel and previous pixel in a horizontal direction in the unprocessed pixel data. A boundary judging circuit judges presence of a boundary between a low-gradation area and a high-gradation area in the horizontal direction of the unprocessed pixel data, based on a comparison between the gradation level difference and a prescribed threshold value. A selecting circuit selects an output of the first bit-shift part when the boundary judging circuit judges there is no boundary, and selects an output of the second bit-shift part when judged there is a boundary.

### BACKGROUND OF THE INVENTION

1. Field of the Invention

The present invention relates to an image processing device which performs pseudo multi-gradation processing on pixel data (mainly color images).

2. Description of the Related Art

Conventionally, as pseudo multi-gradation processing such as color reduction processing performed on pixel data, known is a noise shaping technique which, when a bit precision of an output device is lower than the number of bits of inputted pixel data, discards information of a lower bit of the pixel data so as to be suited for the bit precision of the output device.

FIG. 10 shows a structure of accumulative adding processing performed in a typical noise shaping technique. An accumulative added data generating circuit 2 generates accumulative added data from data of a lower (m-n)-bit of pixel data generated by an adding circuit 4 and a random number value of the (m-n)-bits generated by a random number generating circuit 1, and has the accumulative added data held at a previous data latch circuit 3. The adding circuit 4 adds the accumulative added data of (m-n)-bit obtained from the data latch circuit 3 to the m-bit pixel data inputted successively. A bit-shift part 5 generates n-bit pixel data that is shifted by (m-n)-bit from the pixel data outputted from the adding circuit 4. The image processing described above is executed for each pixel, and the information of the thinned-out lower bit is accumulatively added to the pixel data that is inputted next. Thereby, pseudo multi-gradation processing can be achieved. Through this, reproducibility of colors of image data in a display device can be improved.

In the above-described accumulative adding processing, when there exists a boundary (such as a contour) between a low-gradation area and a high-gradation area within a screen, an accumulative added value of nonuniform lower-bit is added to the pixel data also at the boundary. As a result, uniformity of the gradations cannot be maintained, thereby generating blurring of the contour at the boundary. This may induce deteriorations of the picture quality.

### SUMMARY OF THE INVENTION

The main object of the present invention therefore is to avoid deteriorations of the picture quality by preventing blurring of the contour generated at the boundary between the low-gradation area and the high-gradation area, which is caused because of pseudo multi-gradation processing.

An image processing device according to the present invention comprises: a noise shaping processing part for performing noise shaping processing on pixel data; an adding circuit for performing accumulative adding processing on said pixel data to which said noise shaping processing is applied; a first bit-shift part for performing bit-shift processing on said accumulatively added and noise-shaped pixel data; a second bit-shift part for performing bit-shift processing on unprocessed pixel data to which said noise shaping processing is not applied; an inter-pixel subtracting circuit for calculating a gradation level difference between a current pixel and a previous pixel which are neighboring to each other in a horizontal direction in the unprocessed pixel data; a boundary judging circuit for judging presence of a boundary between a low-gradation area and a high-gradation area in the horizontal direction of the pixel data, based on a comparison between the gradation level difference and a prescribed threshold value; and a selecting circuit which selects an output of the first bit-shift part when the boundary judging circuit judges that there is no boundary, and selects an output of the second bit-shift part when the boundary judging circuit judges that there is a boundary.

With the structure described above, when the gradation level difference between the neighboring pixels in the horizontal direction calculated by the inter-pixel subtracting circuit is less than the prescribed threshold value, the boundary judging circuit judges that there is no boundary between the low-gradation area and the high-gradation area in the horizontal direction. Inversely, when the gradation level difference between the neighboring pixels in the horizontal direction is equal to the prescribed threshold value or larger, the boundary judging circuit judges that there is a boundary. When judged by the inter-pixel subtracting circuit and the boundary judging circuit in cooperation that there is no boundary between the low-gradation area and the high-gradation area in the horizontal direction, the output of the first bit-shift part is selected by the selecting circuit, and the accumulative adding processing is executed. In the meantime, when judged that there is a boundary, the bit-shifted pixel data that is the output of the second bit-shift part is selected by the selecting circuit. In this case, no accumulative adding processing is executed. In this manner, ON/OFF action of the accumulative adding processing is switched in accordance with the judgment result regarding presence of a boundary between the low-gradation area and the high-gradation area in the horizontal direction. As a result, noise shaping processing on the boundary can be prohibited. This makes it possible to prevent generation of blurring in the contour at the boundary in the horizontal direction, which is caused when the uniformity of the gradations cannot be maintained because the nonuniform lower bit information is added.

Further, an image processing device according to the present invention comprises: a noise shaping processing part for performing noise shaping processing on pixel data; an adding circuit for performing accumulative adding processing on said pixel data to which said noise shaping processing is applied; a first bit-shift part for performing bit-shift processing on said accumulatively added and noise-shaped pixel data; a second bit-shift part for performing bit-shift processing on unprocessed pixel data to which said noise shaping processing is not applied; an inter-pixel subtracting circuit for calculating a gradation level difference between a current pixel and a previous pixel which are neighboring to each other in a horizontal direction in the unprocessed pixel data; a boundary judging circuit for judging presence of a boundary between a low-gradation area and a high-gradation area in the horizontal direction of the unprocessed pixel data, based on a comparison between the gradation level difference and a prescribed threshold value; a contour judging circuit which, based on a result of judgment made by the boundary judging circuit, calculates a same-gradation continuous pixel number that indicates number of continuous pixels in almost a same gradation level in a horizontal direction of the pixel data, and then judges presence of a contour based on a comparison between the same-gradation continuous pixel number and a prescribed contour judging pixel number; and a selecting circuit which selects an output of the first bit-shift part when the contour judging circuit judges that there is no contour, and selects an output of the second bit-shift part when the boundary judging circuit judges that there is a contour.

With this structure, the followings are performed in addition to those executed in the above-described structure. That is, this structure calculates the same-gradation continuous pixel number in the horizontal direction, judges whether or not the boundary between the low-gradation area and the high-gradation area in the horizontal direction is a contour based on the same-gradation continuous pixel number, and switches ON/OFF action of the accumulative adding processing according to the judgment result.

With this structure, not only judgment on a boundary between the low-gradation area and the high-gradation area is performed, but also more concrete judgment, i.e. judgment on a contour, is performed. Thus, pseudo multi-gradation processing, which is corresponding more appropriately to the state of the image, can be achieved. That is, when the same-gradation continuous pixel number is equal to the prescribed contour judging pixel number or larger even if the gradation level difference between the neighboring pixels in the horizontal direction is less than the prescribed value, the boundary between the low-gradation area and the high-gradation area in the horizontal direction is considered as a contour. Thus, no accumulative adding processing is performed thereon. In the meantime, when the same-gradation continuous pixel number is less than the prescribed contour judging pixel number even if the gradation level difference between the neighboring pixels in the horizontal direction is equal to the prescribed value or larger, the boundary between the low-gradation area and the high-gradation area in the horizontal direction is not considered as a contour. The accumulative adding processing is performed thereon. As described, the range of the comparison targets regarding the gradation level difference between the neighboring pixels in the horizontal direction is expanded so as to properly judge whether or not the boundary is a contour. Based on the judgment result, the ON/OFF action of the accumulative adding processing is switched.

Further, an image processing device according to the present invention comprises: a noise shaping processing part for performing noise shaping processing on pixel data; an adding circuit for performing accumulative adding processing on said pixel data to which said noise shaping processing is applied; a first bit-shift part for performing bit-shift processing on said accumulatively added and noise-shaped pixel data; a second bit-shift part for performing bit-shift processing on unprocessed pixel data to which said noise shaping processing is not applied; an inter-line subtracting circuit for calculating a gradation level difference between a current pixel and a previous pixel which are neighboring to each other in a vertical direction in the unprocessed pixel data; a boundary judging circuit for judging presence of a boundary between a low-gradation area and a high-gradation area in the vertical direction of the unprocessed pixel data, based on a comparison between the gradation level difference and a prescribed threshold value; and a selecting circuit which selects an output of the first bit-shift part when the boundary judging circuit judges that there is no boundary, and selects an output of the second bit-shift part when the boundary judging circuit judges that there is a boundary.

This structure judges presence of a boundary on the basis of a gradation level difference between the neighboring pixels in the vertical direction. In this case, a line memory may be used as a device for storing one-line pixel data of a previous line.

With the structure described above, when the gradation level difference between the neighboring pixels in the vertical direction calculated by the inter-line subtracting circuit is less than the prescribed threshold value, the boundary judging circuit judges that there is no boundary between the low-gradation area and the high-gradation area in the vertical direction. Inversely, when the gradation level difference in the vertical direction is equal to the prescribed threshold value or larger, the boundary judging circuit judges that there is a boundary. When judged by the inter-line subtracting circuit and the boundary judging circuit in cooperation that there is no boundary between the low-gradation area and the high-gradation area in the vertical direction, the output of the first bit-shift part is selected by the selecting circuit, and the accumulative adding processing is executed. In the meantime, when judged that there is a boundary, the bit-shifted pixel data that is the output of the second bit-shift part is selected by the selecting circuit. In this case, no accumulative adding processing is executed. As described above, presence of a boundary between the low-gradation area and the high-gradation area in the vertical direction is judged, and the ON/OFF action of the accumulative adding processing is switched according to the judgment result. As a result, noise shaping processing on the boundary can be prohibited. This makes it possible to prevent generation of blurring in the contour at the boundary in the vertical direction, which is caused when the uniformity of the gradations cannot be maintained because the nonuniform lower bit information is added.

Further, an image processing device according to the present invention comprises: a noise shaping processing part for performing noise shaping processing on pixel data; an adding circuit for performing accumulative adding processing on said pixel data to which said noise shaping processing is applied; a first bit-shift part for performing bit-shift processing on said accumulatively added and noise-shaped pixel data; a second bit-shift part for performing bit-shift processing on unprocessed pixel data to which said noise shaping processing is not applied; an inter-line subtracting circuit for calculating a gradation level difference between a current pixel and a previous pixel which are neighboring to each other in a vertical direction in the unprocessed pixel data; a boundary judging circuit for judging presence of a boundary between a low-gradation area and a high-gradation area in the vertical direction of the unprocessed pixel data, based on a comparison between the gradation level difference and a prescribed threshold value; a contour judging circuit which, based on a result of judgment made by the boundary judging circuit, calculates a same-gradation continuous pixel number that indicates number of continuous pixels in almost a same gradation level in the vertical direction of the pixel data, and then judges presence of a contour based on a comparison between the same-gradation continuous pixel number and a prescribed contour judging pixel number; and a selecting circuit which selects an output of the first bit-shift part when the contour judging circuit judges that there is no contour, and selects an output of the second bit-shift part when the boundary judging circuit judges that there is a contour.

This structure calculates the same-gradation continuous pixel number in the vertical direction, judges whether or not the boundary between the low-gradation area and the high-gradation area in the vertical direction is a contour based on the same-gradation continuous pixel number, and switches the ON/OFF action of the accumulative adding processing according to the judgment result.

With this structure, not only judgment on a boundary between the low-gradation area and the high-gradation area is performed, but also more concrete judgment, i.e. judgment on a contour, is performed. Thus, pseudo multi-gradation processing, which is corresponding more appropriately to the state of the image, can be achieved. That is, when the same-gradation continuous pixel number is equal to the prescribed contour judging pixel number or larger even if the gradation level difference between the neighboring pixels in the vertical direction is less than the prescribed value, the boundary between the low-gradation area and the high-gradation area in the horizontal direction is considered as a contour. Thus, no accumulative adding processing is performed thereon. In the meantime, when the same-gradation continuous pixel number is less than the prescribed contour judging pixel number even if the gradation level difference between the neighboring pixels in the vertical direction is equal to the prescribed value or larger, the boundary between the low-gradation area and the high-gradation area in the vertical direction is not considered as a contour. The accumulative adding processing is performed thereon. As described, the range of the comparison targets regarding the gradation level difference between the neighboring pixels in the vertical direction is expanded so as to properly judge whether or not the boundary is a contour. Based on the judgment result, the ON/OFF action of the accumulative adding processing is switched.

Further, an image processing device according to the present invention comprises: a noise shaping processing part for performing noise shaping processing on pixel data; an adding circuit for performing accumulative adding processing on said pixel data to which said noise shaping processing is applied; a first bit-shift part for performing bit-shift processing on said accumulatively added and noise-shaped pixel data; a second bit-shift part for performing bit-shift processing on unprocessed pixel data to which said noise shaping processing is not applied; an inter-frame subtracting circuit for calculating, for every set of pixels at same coordinates, a gradation level difference between a pixel of a current frame and a pixel of a previous frame which are neighboring to each other in a time base direction in the unprocessed pixel data; a boundary judging circuit for judging presence of a boundary between a low-gradation area and a high-gradation area in the time base direction of the unprocessed pixel data, based on a comparison between the gradation level difference and a prescribed threshold value; and a selecting circuit which selects an output of the first bit-shift part when the boundary judging circuit judges that there is no boundary, and selects an output of the second bit-shift part when the boundary judging circuit judges that there is a boundary. In this case, a frame memory may be used as a device for storing one-frame pixel data of the previous frame.

With the structure described above, when the gradation level difference between the neighboring pixels in the time base direction (frame direction) calculated by the inter-frame subtracting circuit is less than the prescribed threshold value, the boundary judging circuit judges that there is no boundary between the low-gradation area and the high-gradation area in the time base direction. Inversely, when the gradation level difference in the time base direction is equal to the prescribed threshold value or larger, the boundary judging circuit judges that there is a boundary. When judged by the inter-frame subtracting circuit and the boundary judging circuit in cooperation that there is no boundary between the low-gradation area and the high-gradation area in the time base direction, the output of the first bit-shift part is selected by the selecting circuit, and the accumulative adding processing is executed. In the meantime, when judged that there is a boundary, the bit-shifted pixel data that is the output of the second bit-shift part is selected by the selecting circuit. In this case, no accumulative adding processing is executed. As described above, presence of a boundary between the low-gradation area and the high-gradation area in the time base direction is judged, and the ON/OFF action of the accumulative adding processing is switched according to the judgment result. Thereby, the noise shaping processing can be controlled. As a result, it becomes possible to prevent generation of blurring in the contour at the boundary in the time base direction, which is caused when the uniformity of the gradations cannot be maintained because the nonuniform lower bit information is added.

In the present invention, the image processing device comprises a threshold value correcting part which judges whether an average luminance level is high or low for each frame and shifts the prescribed threshold value to a higher side for a frame where the average luminance level is high, while shifting the prescribed threshold value to a lower side for a frame where the average luminance level is low.

With this, following effects can be obtained. That is, an image whose average luminance level is so high that it exceeds a certain upper limit provides a relatively low luminance efficiency for human beings, so that it tends to become hard to be recognized visually. Meanwhile, an image whose average luminance level is so low that it exceeds a certain lower limit provides relatively high luminance efficiency for human beings, which also tends to become hard to be recognized visually. When the current frame is a frame with a high average luminance level, the threshold value correcting device shifts the standard threshold value to the higher side so as to promote the accumulative adding processing to be executed in the processing of a latter stage. As a result, the image with the high average luminance level can be easily recognized visually. Further, when the current frame is a frame with a low average luminance level, the threshold value correcting device shifts the standard threshold value to the lower side so as to promote unexecution of the accumulative adding processing in the processing of a latter stage. As a result, the image with the low average luminance level can also be easily recognized visually.

The threshold value correcting device comprises: an average luminance level judging circuit which, based on a comparison between an average luminance level of a previous frame and an average luminance level judging reference, judges whether an average luminance level of a current frame is high or low, and calculates a luminance difference absolute value between the average luminance level and the average luminance level judging reference; a first threshold-value adjusting value generating circuit for generating a first threshold-value adjusting value by multiplying a first gain and the luminance difference absolute value; a second threshold-value adjusting value generating circuit for generating a second threshold-value adjusting value by multiplying a second gain and the luminance difference absolute value; an adding circuit for adding the first threshold-value adjusting value to the prescribed threshold value; a subtracting circuit for subtracting the second threshold-value adjusting value from the prescribed threshold value; and a selecting circuit which selects an output of the adding circuit when the average luminance level judging circuit judges that the average luminance level of the current frame is high, and selects an output of the subtracting circuit when the average luminance level of the current frame is low. Further, the first threshold-value adjusting value generating circuit and the second threshold-value adjusting value generating circuit may optionally change the gains. With this structure, it becomes possible to finely adjust the shift amount of the corrected threshold value to the higher side or to the lower side by adjusting the gains.

The present invention judges presence of a boundary between a low-gradation area and a high-gradation area, switches ON/OFF action of the accumulative adding processing appropriately according the judgment result, and prohibits noise shaping processing on the boundary. Therefore, it is possible to avoid deteriorations of the picture quality by preventing blurring of the contour generated at the boundary between the low-gradation area and the high-gradation area, which is caused because of the pseudo multi-gradation processing.

The image processing device of the present invention is effective for a liquid crystal driver, an organic EL driver, and the like, which uses noise shaping (pseudo multi-gradation display) that discards lower bit information of pixel data to thin out the bit so as to be aligned with the bit precision of an output device, when the bit precision of the output device is lower than the number of bits of the inputted pixel data.

### BRIEF DESCRIPTION OF THE DRAWINGS

Other objects of the present invention will become clear from the following description of the preferred embodiments and the appended claims. Those skilled in the art will appreciate that there are many other advantages of the present invention made possible by embodying the present invention.

FIG. 1 is a block diagram for showing a structure of an image processing device according to a first embodiment of the present invention;

FIG. 2A is a flowchart for showing an operation of the image processing device according to the first embodiment of the present invention;

FIG. 2B is an illustration for showing relations between each gradation area and respective processing;

FIG. 3 is a block diagram for showing a structure of an image processing device according to a second embodiment of the present invention;

FIG. 4 is a first flowchart for showing an operation of the image processing device according to the second embodiment of the present invention;

FIG. 5A is a second flowchart for showing an operation (contour judging processing) of the image processing device according to the second embodiment of the present invention;

FIG. 5B is an illustration for showing relations between each gradation area and respective processing;

FIG. 6 is a block diagram for showing a structure of an image processing device according to a third embodiment of the present invention;

FIG. 7 is a block diagram for showing a structure of an image processing device according to a fourth embodiment of the present invention;

FIG. 8 is a block diagram for showing a structure of an image processing device according to a fifth embodiment of the present invention;

FIG. 9 is a block diagram for showing a structure of a threshold value correcting device according to a sixth embodiment of the present invention; and

FIG. 10 is an internal block diagram showing noise shape processing according to a conventional technique.

### DETAILED DESCRIPTION OF THE INVENTION

Hereinafter, embodiments of an image processing device according to the present invention will be described in detail by referring to the accompanying drawings.

### First Embodiment

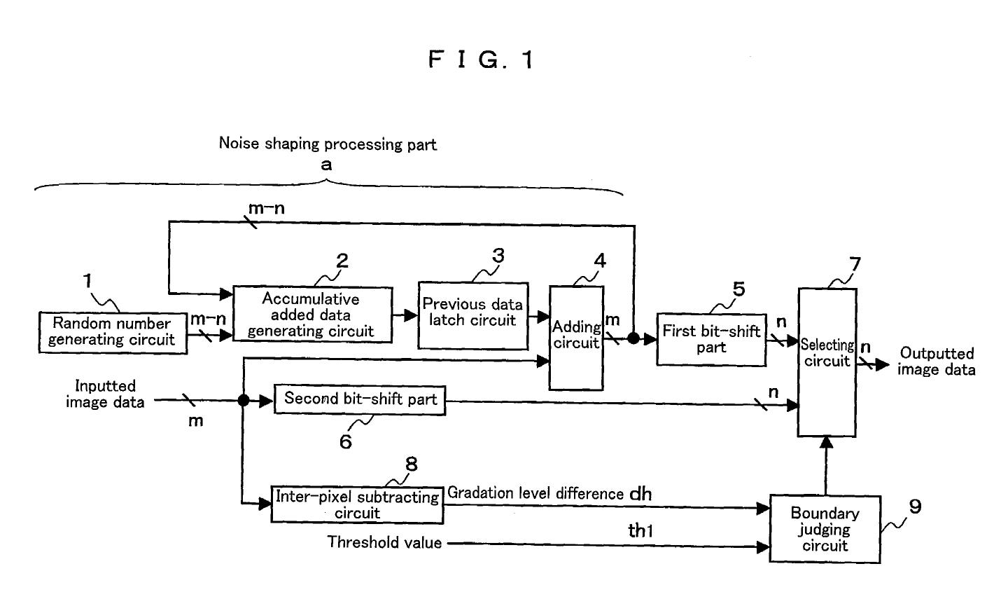

FIG. 1 is a block diagram for showing a structure of an image processing device according to a first embodiment of the present invention. In FIG. 1, reference code a is a noise shaping processing part. The noise shaping processing part a comprises a random number generating circuit 1, an accumulative added data generating circuit 2, a previous data latch circuit 3, and an adding circuit 4. The noise shaping processing part a performs accumulative adding operation on inputted pixel data for performing noise shaping processing. The accumulative added data generating circuit 2 generates accumulative added data from data of a lower (m-n)-bit pixel data generated by the adding circuit 4 and a random number value of (m-n)-bit generated by the random number generating circuit 1. The previous data latch circuit 3 holds the accumulative added data that is outputted from the accumulative added data generating circuit 2. The adding circuit 4 adds m-bit pixel data that is inputted from outside and (m-n)-bit data that is supplied from the previous data latch circuit 3.

Reference numeral 5 is a first bit-shift part. The first bit-shift part 5 performs bit-shift of (m-n)-bit on the m-bit pixel data that is a result of accumulative adding operation obtained from the adding circuit 4 of the noise shaping processing part a so as to generate n-bit pixel data. Reference numeral 6 is a second bit-shift part. The second bit-shift part 6 performs bit-shift of (m-n)-bit on inputted unprocessed pixel data, to which said noise shaping processing is not applied, so as to generate n-bit pixel data. Reference numeral 7 is a selecting circuit. The selecting circuit 7 selects either the bit-shifted pixel data obtained by the first bit-shift part 5 or the simply bit-shifted data obtained by the second bit-shift part 6. Reference numeral 8 is an inter-pixel subtracting circuit. The inter-pixel subtracting circuit 8 subtracts a gradation level of previous pixel data from a gradation level of current pixel data in the horizontal direction of the inputted pixel data so as to calculate a gradation level difference dh between the neighboring pixels in the horizontal direction. Reference numeral 9 is a boundary judging circuit. The boundary judging circuit 9 judges presence of a boundary between a low-gradation area and a high-gradation area in the horizontal direction by comparing the gradation level difference dh between the neighboring pixels in the horizontal direction obtained by the inter-pixel subtracting circuit 8 with a prescribed threshold value th1, and controls the selecting circuit 7 based on a result of the judgment. Specifically, the boundary judging circuit 9 judges that there is no boundary, when the gradation level difference dh between the neighboring pixels in the horizontal direction is less than the threshold value th1, and judges that there is a boundary, when the gradation level difference dh between the neighboring pixels in the horizontal direction is equal to the threshold value th1 or larger. When the result of the judgment made by the boundary judging circuit 9 indicates that there is no boundary, the selecting circuit 7 selects the bit-shifted pixel data from the first bit-shift part 5 with the noise shaping processing and, when the result of the judgment indicates that there is a boundary, selects the simply bit-shifted pixel data from the second bit-shift part 6.

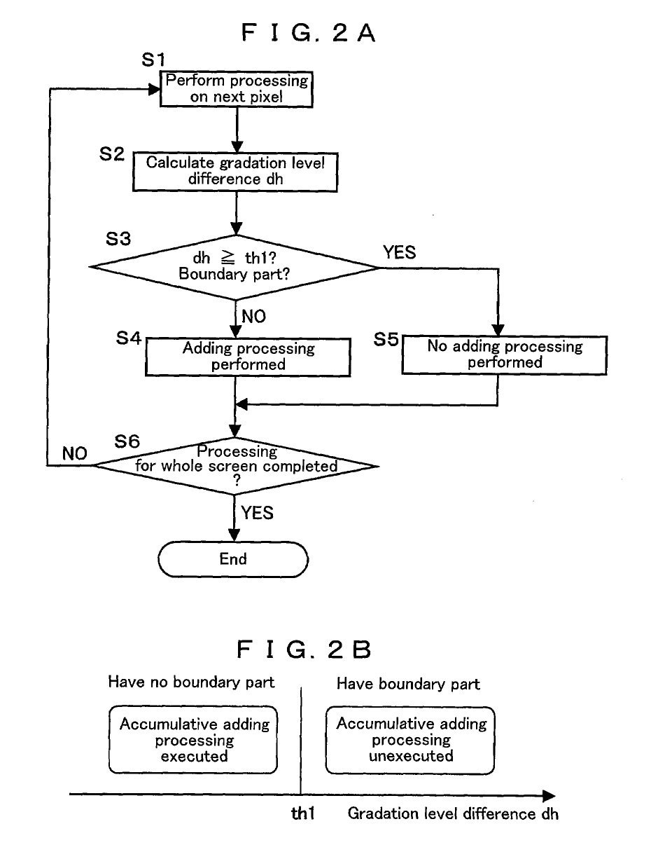

Next, an operation of the image processing device according to the embodiment that is structured in the above-described manner will be described by referring to a flowchart of FIG. 2A. First, in step S1, successively inputted pixel data is updated. Then, in step S2, the inter-pixel subtracting circuit 8 subtracts a gradation level of previous pixel data from a gradation level of current pixel data in the horizontal direction of the inputted pixel data so as to calculate the gradation level difference dh between the neighboring pixels in the horizontal direction.

Then, in step S3, the boundary judging circuit 9 judges presence of a boundary between a low-gradation area and a high-gradation area in the horizontal direction by comparing the gradation level difference dh between the neighboring pixels in the horizontal direction, which is calculated in the step S2, with the prescribed threshold value th1. Specifically, the boundary judging circuit 9 judges that there is no boundary when the gradation level difference dh between the neighboring pixels in the horizontal direction is less than the threshold value th1. When the boundary judging circuit 9 makes this judgment, the procedure is advanced to step S4. Inversely, the boundary judging circuit 9 judges that there is a boundary when the gradation level difference dh between the neighboring pixels in the horizontal direction is equal to the threshold value th1 or larger. When the boundary judging circuit 9 makes this judgment, the procedure is advanced to step S5.

In the step S4 proceeded after judging that there is no boundary, the boundary judging circuit 9 controls the selecting circuit 7 to select the m-n bit-shifted pixel data from the first bit-shift part 5 with the noise shaping processing and execute accumulative adding processing so as to improve the lower bit precision of the image in a pseudo manner (see left section of FIG. 2).

In the meantime, in the step S5 proceeded after judging that there is a boundary, the boundary judging circuit 9 controls the selecting circuit 7 to select the pixel data that is simply bit-shifted by (m-n)-bit by the second bit-shift part 6. In this case, no accumulative adding processing is executed (see right section of FIG. 2B).

In step S6 proceeded after the step S4 or the step S5, it is judged whether or not processing has been completed on all the inputted pixel data for one screen. If the inputted data is not the last one (if all the pixel data for one screen are not processed), the procedure is returned to the step S1 to shift to the processing for the next inputted pixel data. If the inputted data is the last one (if all the pixel data for one screen are being processed), it is judged as the last inputted pixel data. Thereby, the processing for one screen has been completed.

As described above, in the embodiment, following actions are executed. That is: the gradation level difference dh between the neighboring pixels in the horizontal direction is calculated; presence of a boundary between the low-gradation area and the high-gradation area in the horizontal direction is judged based on the gradation level difference dh; ON/OFF action of the accumulative adding processing is switched appropriately in accordance with a result of the judgment; and the noise shaping processing on the boundary is prohibited. Therefore, it becomes possible to suppress deteriorations of the picture quality by preventing generation of blurring in the contour at the boundary in the horizontal direction, which is caused because the uniformity of the gradations cannot be maintained as a result of adding the nonuniform lower bit information.

### Second Embodiment

A second embodiment of the present invention is the same as the first embodiment, except that the second embodiment further calculates the number of continuous pixels of a same gradation in the horizontal direction and judges, based on the calculated number of continuous pixels of the same gradation, whether or not the boundary between the low-gradation area and the high-gradation area in the horizontal direction is a contour. Then, ON/OFF action of the accumulative adding processing is controlled in accordance with a result of the judgment.

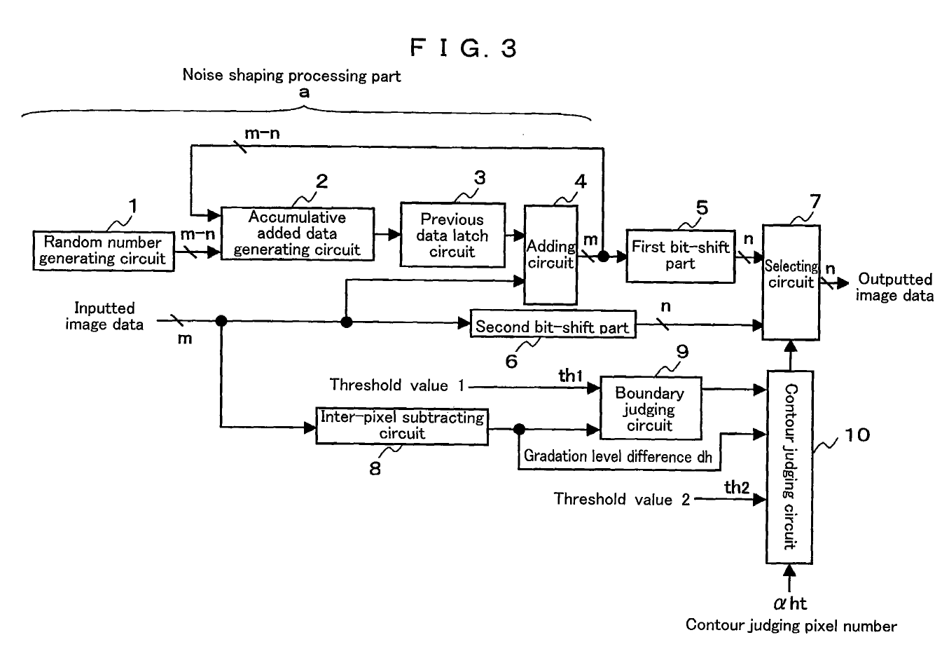

FIG. 3 is a block diagram for showing a structure of an image processing device according to the second embodiment of the present invention. In FIG. 3, same reference numerals as those of FIG. 1 showing the first embodiment indicate the same structural elements.

Reference numeral 10 is a contour judging circuit. The contour judging circuit 10 performs the followings.
Processing for comparing the gradation level difference dh between the neighboring pixels in the horizontal direction obtained by the inter-pixel subtracting circuit 8 with a second threshold value th2 (smaller than the first threshold value th1) (in this embodiment, the same threshold value as the prescribed threshold value th1 of the first embodiment is referred to as a first threshold value th1 hereinafter so as to discriminate it from the second threshold value th2)
Processing for calculating same-gradation continuous pixel number αh in the horizontal direction, when it is judged in the above-described comparing processing that the gradation level difference dh between the neighboring pixels in the horizontal direction is equal to the second threshold value th2 or smaller
Processing for judging presence of a contour by comparing the same-gradation continuous pixel number αh that is calculated in the above-described calculating processing with a prescribed contour judging pixel number αht

When judged in the above-described contour judging processing that the same-gradation continuous pixel number αh in the horizontal direction is equal to the contour judging pixel number αht or larger, the contour judging circuit 10 judges that the boundary between the low-gradation area and the high-gradation area in the horizontal direction is a contour. Inversely, when judged that the same-gradation continuous pixel number αh is less than the contour judging pixel number αht, the contour judging circuit 10 judges that the above-described boundary is not a contour.

When the result of the judgment made by the contour judging circuit 10 by the contour judging circuit 10 indicates that it is not a contour, the selecting circuit 7 selects the bit-shifted pixel data from the first bit-shift part 5 with noise shaping processing regardless of the result of the judgment made by the boundary judging circuit 9. Inversely, when the result of the judgment made by the contour judging circuit 10 indicates that it is a contour, the selecting circuit 7 selects the simply bit-shifted pixel data by the second bit-shift part 6 regardless of the result of the judgment made by the boundary judging circuit 9. Other structures of the second embodiment are the same as those of the first embodiment, so that explanations thereof will be omitted.

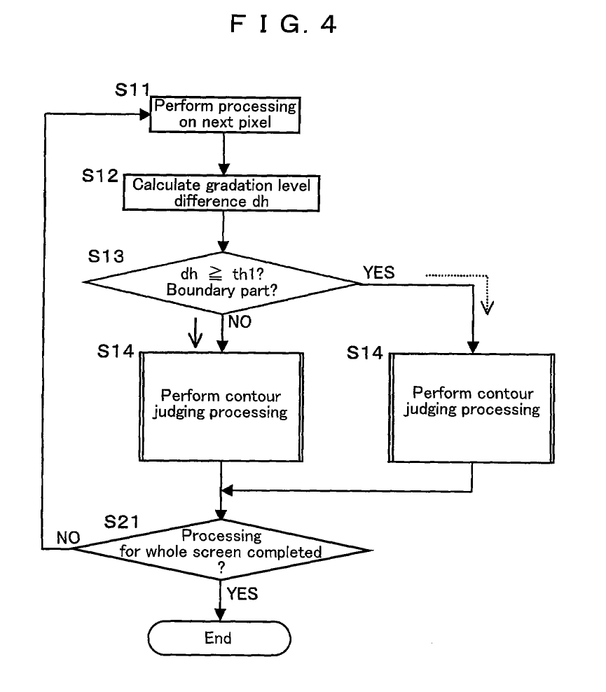

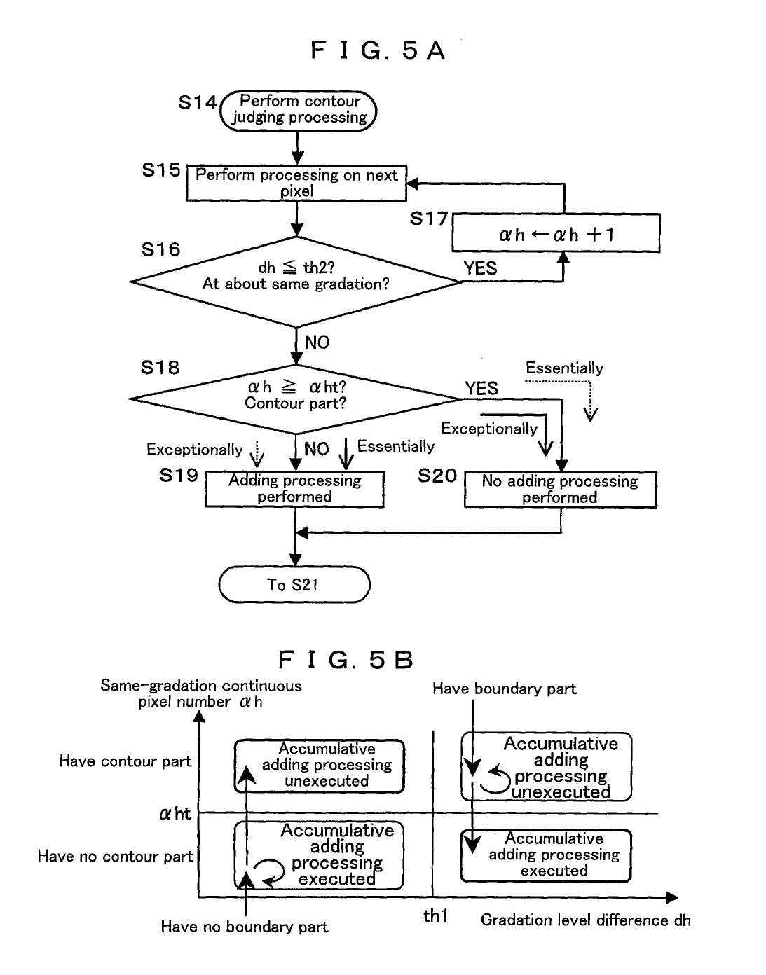

Next, operations of the image processing device according to the second embodiment structured in the above-described manner will be described by referring to flowcharts of FIG. 4 and FIG. 5A. First, in step S11, successively inputted pixel data is updated. Then, in step S12, the inter-pixel subtracting circuit 8 subtracts the gradation level of previous pixel data from the gradation level of current pixel data in the horizontal direction of the inputted pixel data so as to calculate the gradation level difference dh between the neighboring pixels in the horizontal direction.

Then, in step S13, the boundary judging circuit 9 judges presence of a boundary between the low-gradation area and the high-gradation area in the horizontal direction by comparing the gradation level difference dh between the neighboring pixels in the horizontal direction, which is calculated in the step S12, with the first threshold value th1. That is, the boundary judging circuit 9 judges that there is no boundary, when the gradation level difference dh between the neighboring pixels in the horizontal direction is less than the first threshold value th1. Inversely, the boundary judging circuit 9 judges that there is a boundary, when the gradation level difference dh between the neighboring pixels in the horizontal direction is equal to the first threshold value th1 or larger. In both cases, the procedure is advanced to step S14, and steps from S14 to S18 are executed so as to perform contour judging processing.

Hereinafter, the contour judging processing will be described. In step S15, the successively inputted pixel data is updated further. Then, in step S16, the contour judging circuit 10 compares the gradation level difference dh between the neighboring pixels in the horizontal direction calculated in the step S12 with the second threshold value th2 to judge whether or not the neighboring pixels are at about the same gradation. When judging that dh≦th2 and that the neighboring pixels are at about the same gradation, the procedure is advanced to step S17 where the contour judging circuit 10 increments the variable ah that represents the continuous pixel number of the same gradation in which the gradation level difference dh between the neighboring pixels is equal to the second threshold value th2 or smaller so as to calculate the same-gradation continuous pixel number ah. Then, the procedure is returned to the step S15 to start processing on the next inputted data. When judged that dh>th2 and that the neighboring pixels are not at about the same gradation, the procedure is advanced to step S18.

In the step S18, the contour judging circuit 10 judges whether or not the same-gradation continuous pixel number αh is equal to a contour judging pixel number αht or larger. When the result thereof indicates that the gradation continuous number α is less than the contour judging pixel number αht, the contour judging circuit 10 judges that the boundary having the gradation continuous number α is not a contour. Then, the procedure is advanced to step S19. In the step S19, the contour judging circuit 10 controls the selecting circuit 7 to select the pixel data shifted by (m-n)-bit by the first bit-shift part 5 with noise shaping processing, and executes the accumulative adding processing thereon. Specifically, even when it is judged by the boundary judging circuit 9 in the step S13 that the pixel area is a boundary between a low-gradation area and a high-gradation area (see right section of FIG. 5), if it is judged by the contour judging circuit 10 in the step S18 that the boundary is not a contour because the same-gradation continuous pixel number is small, noise shaping processing is executed (see lower part of right section in FIG. 5B), unlike the case of the first embodiment. When judged by the boundary judging circuit 9 in the step S13 that the pixel area is not a boundary between the low-gradation area and the high gradation area (see left section of FIG. 5B), the same processing as that of the first embodiment is executed (see lower part of the left section in FIG. 5B).

In the meantime, it is judged by the contour judging circuit 10 in the step S18 that the same-gradation continuous pixel number αh is equal to the contour judging pixel number αht or larger, it is considered that the boundary is a contour. Then, the procedure is advanced to step S20. In the processing of the step S20, the contour judging circuit 10 controls the selecting circuit 7 to select the pixel data that is simply shifted by (m-n)-bit by the second bit-shift part 6. In this case, no accumulative adding processing is executed.

The processing of the steps S18 and S20 will be described in more details. Even when it is judged by the boundary judging circuit 9 in the step S13 that the pixel area is not a boundary between the low-gradation area and the high-gradation area (see left section of FIG. 5), if it is judged by the contour judging circuit 10 in the step S18 that the same-gradation continuous pixel number is equal to the contour judged pixel number αht or larger, it is judged that the pixel area that is determined as not being a boundary in the step S13 is actually a contour. When such judgment is made, no noise shaping processing is executed (see upper part of the left section in FIG. 5B), unlike the case of the first embodiment. When judged in the step S13 that the pixel area is a boundary between the low-gradation area and the high-gradation area (see right section of FIG. 5B), the same processing as that of the first embodiment is performed (see upper part of the right section in FIG. 5B).

As described above, even when it is judged that the gradation level difference dh between the neighboring pixels in the horizontal direction is equal to the first threshold value th1 or larger, if it is judged that the same-gradation continuous pixel number αh is less than the contour judging pixel number αht, the accumulative adding processing is performed. In the meantime, when it is judged that the gradation level difference dh between the neighboring pixels in the horizontal direction is less than the first threshold value th1 and it is also judged that the same-gradation continuous pixel number αh is equal to the contour judging pixel number αht or larger, no accumulative adding processing is performed.

In step S21 proceeded after the step S19 or the step S20, it is judged whether or not the processing on all the inputted pixel data for one screen has been completed. If the inputted pixel data is not the last one, it is judged that the processing for the whole screen has not been completed. Thus, the procedure is returned to the step S11 to start the processing on the next inputted pixel data. When the inputted pixel data is the last one, it is judged that the processing for the whole screen has been completed. Thereby, the processing for that one screen is ended.

As described above, in this embodiment, the contour judging circuit 10 is interposed between the boundary judging circuit 9 and the selecting circuit 7. With this, even when a boundary (which exists between the low-gradation area and the high-gradation area in the horizontal direction) is not considered as a contour when judged only by the boundary judging circuit 9 which detects the gradation level difference dh between the neighboring pixels in the horizontal direction of the pixel data (difference between the pixel data of the current pixel and the pixel data of the previous pixel) is less than the first threshold value th1 (dh<th1), the contour judging circuit 10 judges the boundary as a contour if it judges the same-gradation continuous pixel number αh is equal to the contour judging pixel number αht or larger (αh≧αht). Based on such judgment made by the contour judging circuit 10, noise shaping processing is performed to execute the accumulative adding processing between the start pixel and the next pixel and between the end pixel and the next pixel of the continuous pixel data in the horizontal direction. In the meantime, even when a boundary is considered as a contour by the boundary judging circuit 9 which detects the gradation level difference dh between the neighboring pixels in the horizontal direction is equal to the first threshold value th1 or larger (dh≧th1), the contour judging circuit 10 judges that the boundary is not a contour if the same-gradation continuous pixel number αh is less than the contour judged pixel number αht (αh<αht). Based on such judgment made by the contour judging circuit 10, the above-described accumulative adding processing is performed.

In this embodiment, the range of the comparison targets regarding the gradation level difference dh between the neighboring pixels in the horizontal direction is expanded, which makes it possible to make judgments with still higher accuracy, regarding whether or not the boundary is a contour of an object. Based on the judgments, ON/OFF action of the accumulative adding processing is switched. That is, not only by making judgment on a boundary between the low-gradation area and the high-gradation area but also by making more concrete judgment regarding a contour, pseudo multi-gradation processing, which is corresponding more appropriately to the state of the image, can be achieved.

### Third Embodiment

A third embodiment of the present invention judges presence of a boundary on the basis of a gradation level difference dv between the neighboring pixels in the vertical direction, whereas the first embodiment judges the presence of the boundary on the basis of the gradation level difference dh between the neighboring pixels in the horizontal direction.

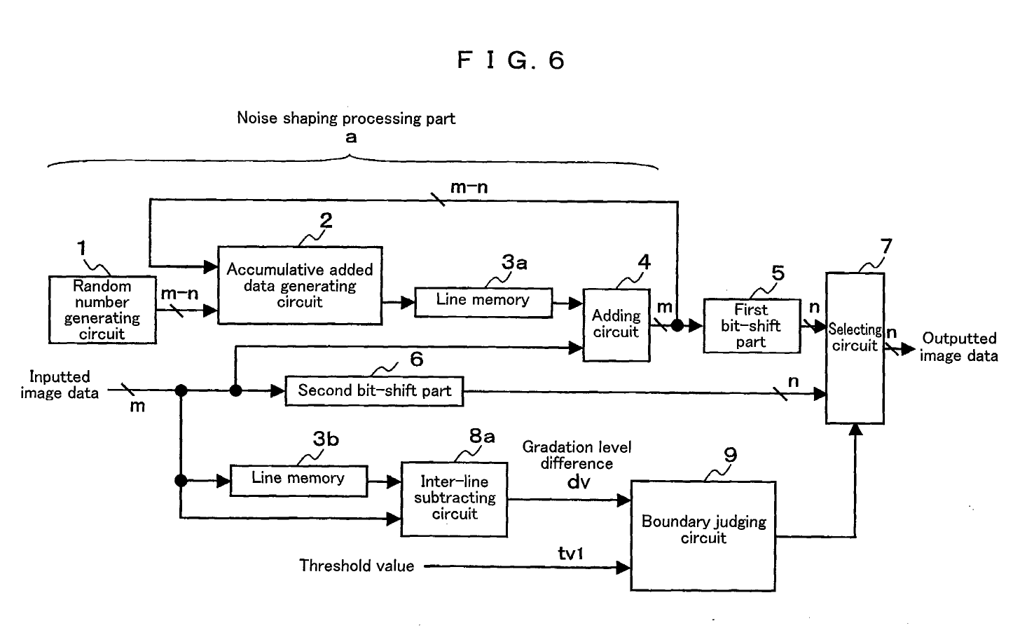

FIG. 6 is a block diagram for showing a structure of an image processing device according to the third embodiment. In FIG. 6, the same reference numerals as those of FIG. 1 according to the first embodiment indicate the same structural elements. Reference numeral 3a is a line memory for storing output error data of the accumulative added data generating circuit 2 for one horizontal period, and 3b is a line memory for storing inputted pixel data for one horizontal period. In this embodiment, the adding circuit 4 adds, by each line, pixel data of m-bits inputted from outside and output error data of (m-n)-bit supplied from the line memory 3a. Further, an inter-line subtracting circuit 8a subtracts, from a gradation level of pixel data of a current line, a gradation level of pixel data of a previous line at the same position outputted from the line memory 3b, so as to calculate the gradation level difference dv in the vertical direction. Further, the boundary judging circuit 9 compares the gradation level difference dv in the vertical direction calculated by the inter-line subtracting circuit 8a with a prescribed threshold value tv1 to judge presence of a boundary between a low-gradation area and a high-gradation area in the vertical direction, and controls the selecting circuit 7 according to a result of the judgment. Specifically, when the gradation level difference dv in the vertical direction is less than the threshold value tv1, the boundary judging circuit 9 judges that there is no boundary. When the gradation level difference dv in the vertical direction is equal to the threshold value tv1 or larger, the boundary judging circuit 9 judges that there is a boundary. Other structures are the same as those of the first embodiment, so that explanations thereof will be omitted.

Next, operations of the image processing device according to the embodiment structured in the above-described manner will be described. Upon receiving accumulatively-added error data outputted from the accumulative added data generating circuit 2, the pixel data for one horizontal period is stored in the line memory 3a. Then, the adding circuit 4 adds, to the pixel data at a certain position of the current line, the error data of the pixel at the same position of the previous line outputted from the line memory 3a so as to add information of the gradation that is higher than the gradation that can be displayed in the output device. The first bit-shift part 5 outputs higher n-bit data that is shifted by (m-n)-bit. This makes it possible to perform accumulative adding processing by each line. The second bit-shift part 6 outputs higher n-bit data that is obtained by shifting the inputted pixel data by (m-n)-bit.

The line memory 3b stores the inputted pixel data for one horizontal period. The inter-line subtracting circuit 8a subtracts, from a gradation level of pixel data of a current line, a gradation level of pixel data of a previous line outputted from the line memory 3b, so as to calculate the gradation level difference dv in the vertical direction. That is, the inter-line subtracting circuit 8a calculates the gradation level difference dv in the vertical direction by each pixel between the upper and lower lines. For the understanding of operation of the boundary judging circuit 9, “perform processing on the next pixel” in the step S1 shown in the flowchart of FIG. 2 according to the first embodiment may be replaced with “perform processing on a pixel of the next line”. That is, the boundary judging circuit 9 compares the gradation level difference dv in the vertical direction with the prescribed threshold value tv1 to judge presence of a boundary between a low-gradation area and a high-gradation area in the vertical direction. When the gradation level difference dv in the vertical direction is less than the threshold value tv1, the boundary judging circuit 9 judges that there is no boundary between the low-gradation area and the high-gradation area in the vertical direction. Inversely, when the gradation level difference dv in the vertical direction is equal to the threshold value tv1 or larger, the boundary judging circuit 9 judges that there is a boundary. When the boundary judging circuit 9 judges that there is no boundary, the selecting circuit 7 selects the pixel data that is shifted by (m-n)-bit by the first bit-shift part 5 with noise shaping processing and executes the accumulative adding processing so as to improve the lower bit precision of the image in a pseudo manner. In the meantime, when the boundary judging circuit 9 judges that there is a boundary, the selecting circuit 7 selects the pixel data that is simply shifted by (m-n)-bit by the second bit-shift part 6, and performs no accumulative adding processing.

As described above, with the embodiment, the gradation level difference dv in the vertical direction is calculated, and presence of a boundary between a low-gradation area and a high-gradation area in the vertical direction is judged based on the gradation level difference dv in the vertical direction. Based on a result of the judgment, ON/OFF action of the accumulative adding processing is switched appropriately, so that noise shaping processing on the boundary can be prohibited. This makes it possible to suppress deteriorations of the picture quality by preventing generation of blurring in the contour at the boundary in the vertical direction, which is caused when the uniformity of the gradation cannot be maintained because the nonuniform lower bit information is added.

### Fourth Embodiment

A fourth embodiment of the present invention, in addition to the operations of the above-described third embodiment, calculates the same-gradation continuous pixel number in the vertical direction, judges whether or not a boundary between a low-gradation area and a high-gradation area in the vertical direction is a contour based on the calculated same-gradation continuous pixel number, and switches ON/OFF action of the accumulative adding processing according to a result of the judgment.

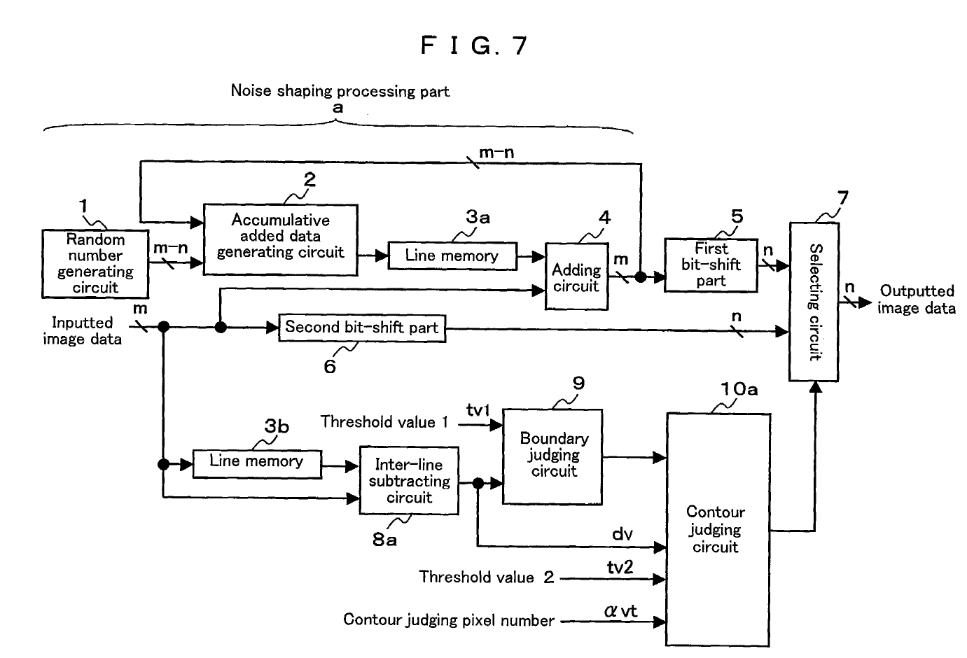

FIG. 7 is a block diagram for showing a structure of an image processing device according to a fourth embodiment of the present invention. In FIG. 7, the same reference numerals as those of FIG. 6 according to the third embodiment indicate the same structural elements. Reference numeral 10a is a contour judging circuit. The contour judging circuit 10a performs the followings.
Processing for comparing the gradation level difference dv between the neighboring pixels in the vertical direction calculated by the inter-line subtracting circuit 8a with a second threshold value tv2 that is smaller than the first threshold value tv1 (in this embodiment, the same threshold value as the prescribed threshold value tv1 of the third embodiment is referred to as a first threshold value tv1 hereinafter so as to discriminate it from the second threshold value tv2)
Processing for calculating same-gradation continuous pixel number αv in the vertical direction, when it is judged in the above-described comparing processing that the gradation level difference dv is equal to the second threshold value tv2 or smaller
Processing for judging presence of a contour by comparing the same-gradation continuous pixel number αv with a prescribed contour judging pixel number αvt

When judged in the above-described contour judging processing that the same-gradation continuous pixel number αv in the vertical direction is equal to the contour judging pixel number αvt or larger, the contour judging circuit 10a judges that the boundary between the low-gradation area and the high-gradation area in the vertical direction is a contour. Inversely, when judged that the same-gradation continuous pixel number αv is less than the contour judging pixel number αvt, the contour judging circuit 10a judges that the above-described boundary is not a contour.

When the result of the judgment made by the contour judging circuit 10a indicates that it is not a contour, the selecting circuit 7 selects the bit-shifted pixel data from the first bit-shift part 5 with noise shaping processing regardless of the result of the judgment made by the boundary judging circuit 9. Inversely, when the result of the judgment made by the contour judging circuit 10a indicates that it is a contour, the selecting circuit 7 selects the simply bit-shifted pixel data by the second bit-shift part 6 regardless of the result of the judgment made by the boundary judging circuit 9. Other structures of the second embodiment are the same as those of the third embodiment, so that explanations thereof will be omitted.

Next, operations of the image processing device of the embodiment structured in the above-described manner will be described. The inter-line subtracting circuit 8a subtracts, from the gradation level of the inputted pixel data of a current line, the gradation level of the pixel data of a previous line at the same position supplied from the line memory 3b, so as to calculate the gradation level difference dv in the vertical direction. For the understanding of operation of the boundary judging circuit 9, “perform processing on the next pixel” in the steps S11 shown in the flowchart of FIG. 4 according to the second embodiment may be replaced with “perform processing on a pixel of the next line”. That is, the boundary judging circuit 9 compares the gradation level difference dv in the vertical direction with the first threshold value tv1 to judge presence of a boundary between a low-gradation area and a high-gradation area in the vertical direction. When the gradation level difference dv in the vertical direction is less than the first threshold value tv1, the boundary judging circuit 9 judges that it is not a boundary. Inversely, when the gradation level difference dv in the vertical direction is equal to the first threshold value tv1 or larger, the boundary judging circuit 9 judges that it is a boundary.

For the understanding of operation of the contour judging circuit 10a regarding the contour judging processing, “perform processing on the next pixel” in the flowchart of FIG. 5 according to the second embodiment may be replaced with “perform processing on pixels of the next line”. That is, the contour judging circuit 10a compares the gradation level difference dv between the neighboring pixels in the vertical direction with the second threshold value tv2 to judge whether or not the neighboring pixels in the vertical direction are at about the same gradation. Specifically, when a result of the comparison indicates dv≦th2, the neighboring pixels in the vertical direction are at about the same gradation. Upon making such judgment, the contour judging circuit 10a calculates the same-gradation continuous pixel number αv in which the gradation level difference dv between the neighboring pixels in the vertical direction is equal to the second threshold value tv2 or smaller. In the meantime, when the result of the comparison indicates dv≧dv2, the contour judging circuit 10a judges that the neighboring pixels are not at about the same gradation and judges whether or not the same-gradation continuous pixel number αv is equal to the contour judging pixel number αvt or larger (αv≧αvt). Upon judging that the gradation continuous pixel number α is less than the contour judging pixel number αvt (αv<αvt), the contour judging circuit 10a judges that the boundary is not a contour, and controls the selecting circuit 7 to select the pixel data that is shifted by (m-n)-bit by the first bit-shift part 5 with noise shaping processing, and executes the accumulative adding processing thereon. More specifically, even when it is judged that the pixel area has a boundary between the low-gradation area and the high-gradation area, if the same-gradation continuous pixel number Δv is less than the second threshold value tv2, the contour judging circuit 10a judges that the boundary actually is not a contour and executes noise shaping processing, unlike the case of the third embodiment. When judged that there is no boundary between the low-gradation area and the high gradation area, the same processing as that of the third embodiment is executed.

In the meantime, upon judging that the same-gradation continuous pixel number αv is equal to the contour judging pixel number αvt or larger (αv≧Δvt), the contour judging circuit 10a judges that the boundary is a contour, and controls the selecting circuit 7 to select the pixel data that is simply shifted by (m-n)-bit by the second bit-shift part 6. In this case, no accumulative adding processing is executed. More specifically, even when it is judged that the pixel area has no boundary between the low-gradation area and the high-gradation area, if the same-gradation continuous pixel number αv is equal to the contour judging pixel number αvt or larger (αv≧αvt), the contour judging circuit 10a judges that the boundary is a contour. However, unlike the case of the third embodiment, noise shaping processing is not executed. When judged that the pixel area has a boundary between the low-gradation area and the high gradation area, the same processing as that of the third embodiment is executed without performing the processing described above.

As described above, in this embodiment, the contour judging circuit 10a is interposed between the boundary judging circuit 9 and the selecting circuit 7. With this, even when the gradation level difference dv between the neighboring pixels in the vertical direction of the pixel data (difference between the pixel data of the current line and the pixel data of the previous line) is less than the first threshold value th1 (dv<tv1), if the same-gradation continuous pixel number αv is equal to the contour judging pixel number αvt or larger (αv≧αvt), the contour judging circuit 10a judges that the boundary between the low-gradation area and the high-gradation area in the vertical direction is a contour and noise shaping processing (accumulative adding processing on the next pixels of the start pixel and the end pixel in continuous pixel data groups in the vertical direction) is not performed. In the meantime, upon judging that the same-gradation continuous pixel number αv is less than the contour judging pixel number αvt (αv<αvt) even when the gradation level difference dv between the neighboring pixels in the vertical direction is equal to the first threshold value th1 or larger (dhv≧tv1), the contour judging circuit 10a judges that the boundary between the neighboring pixels in the vertical direction is not a contour, and performs accumulative adding processing. In this manner, the range of the comparison targets regarding the gradation level difference dv between the neighboring pixels in the vertical direction is expanded, which makes it possible to make judgments appropriately regarding whether or not the boundary is a contour, and ON/OFF action of the accumulative adding processing is switched based thereupon. That is, not only by making judgment on a boundary between the low-gradation area and the high-gradation area, but also by making more concrete judgment regarding a contour, it becomes possible to achieve pseudo multi-gradation processing, which is corresponding more appropriately to the state of the image.

### Fifth Embodiment

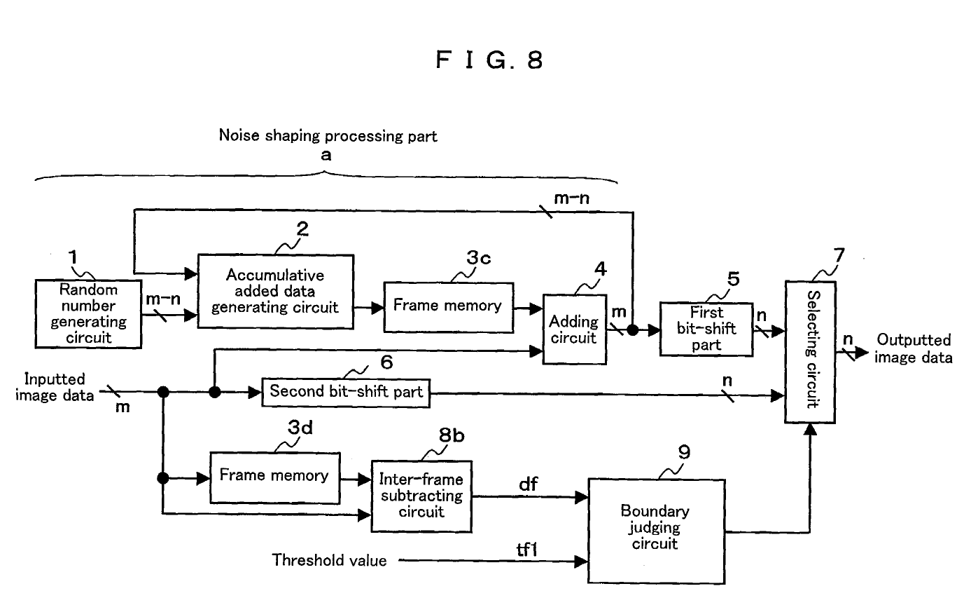

A fifth embodiment of the present invention judges presence of a boundary on the basis of a gradation level difference df between the neighboring pixels in a direction of time base that is between neighboring frames. FIG. 8 is a block diagram for showing a structure of an image processing device according to the fifth embodiment of the present invention. In FIG. 8, the same reference numerals as those of FIG. 6 according to the third embodiment indicate the same structural elements. Reference numeral 3c is a frame memory for storing output error data of the accumulative added data generating circuit 2 for one field period, and 3d is a frame memory for storing inputted pixel data for one vertical period. The adding circuit 4 of this embodiment adds, by each line pixel, data of m-bits inputted from outside and output error data of (m-n)-bit supplied from the frame memory 3c. An inter-frame subtracting circuit 8b subtracts, from a gradation level of pixel data of a current frame, a gradation level of pixel data of a previous frame at the same coordinates outputted from the frame memory 3c, so as to calculate the gradation level difference df in the time base direction. The boundary judging circuit 9 compares the gradation level difference df in the time base direction calculated by the inter-frame subtracting circuit 8b with a prescribed threshold value tf1 to judge presence of a boundary between a low-gradation area and a high-gradation area in the time base direction, and controls the selecting circuit 7 according to a result of the judgment. Specifically, when the gradation level difference df in the time base direction is less than the threshold value tf1, the boundary judging circuit 9 judges that there is no boundary. When the gradation level difference df in the time base direction is equal to the threshold value tf1 or larger, the boundary judging circuit 9 judges that there is a boundary. Other structures are the same as those of the third embodiment, so that explanations thereof will be omitted.

Next, operations of the image processing device according to the embodiment structured in the above-described manner will be described. Upon receiving accumulatively-added error data outputted from the accumulative added data generating circuit 2, the frame memory 3c stores the error data as pixel data for one vertical period. Then, the adding circuit 4 adds, to the pixel data at certain coordinates of a current frame, the error data of the pixel of a previous frame at the same coordinates outputted from the frame memory 3c so as to add information of the gradation that is higher than the gradation that can be displayed in the output device. The first bit-shift part 5 outputs higher n-bit data that is shifted by (m-n)-bit. This makes it possible to perform accumulative adding processing by each frame. The second bit-shift part 6 generates higher n-bit data that is obtained by shifting the inputted pixel data by (m-n)-bit, and outputs the higher n-bit data.

The frame memory 3d stores the inputted pixel data for one vertical period. The inter-frame subtracting circuit 8b calculates the gradation level difference df in the time base direction by performing processing for reading out, from the frame memory 3d, pixel data of a pixel of a previous frame, which is at the same coordinates as the coordinates of a certain interested pixel of a current frame, and processing for subtracting a gradation level of the pixel data of the previous frame from a gradation level of the pixel data of the current frame (both pixels are at the same coordinates).

For the understanding of operation of the boundary judging circuit 9, “perform processing on the next pixel” in the step S1 shown in the flowchart of FIG. 2 according to the first embodiment may be replaced with “perform processing on a pixel of the next frame”. That is, the boundary judging circuit 9 compares the gradation level difference df in the time base direction with the prescribed threshold value tf1 to judge presence of a boundary between a low-gradation area and a high-gradation area in the time base direction. When the gradation level difference df in the time base direction is less than the threshold value tf1, the boundary judging circuit 9 judges that there is no boundary between the low-gradation area and the high-gradation area in the time base direction. Inversely, when the gradation level difference df in the time base direction is equal to the threshold value tf1 or larger, the boundary judging circuit 9 judges that there is a boundary. When judged that there is no boundary, the selecting circuit 7 selects the pixel data shifted by (m-n)-bit by the first bit-shift part 5 with noise shaping processing and executes the accumulative adding processing so as to improve the lower bit precision of the image in a pseudo manner. In the meantime, when judged that there is a boundary, the selecting circuit 7 selects the pixel data that is simply shifted by (m-n)-bit by the second bit-shift part 6, and performs no accumulative adding processing in this case.

As described above, it becomes possible with the embodiment to suppress deteriorations of the picture quality by preventing generation of blurring in a contour at the boundary by performing the followings.
Processing for calculating the gradation level difference df in the time base direction by subtracting the gradation level of the pixel data of the previous frame from the gradation level of the pixel data of the current frame
Processing for judging presence of a boundary between the low-gradation area and the high-gradation area in the time base direction based on the gradation level difference df in the time base direction
Processing for switching ON/OFF action of the accumulative adding processing by corresponding properly to the result of the judgment

### Sixth Embodiment

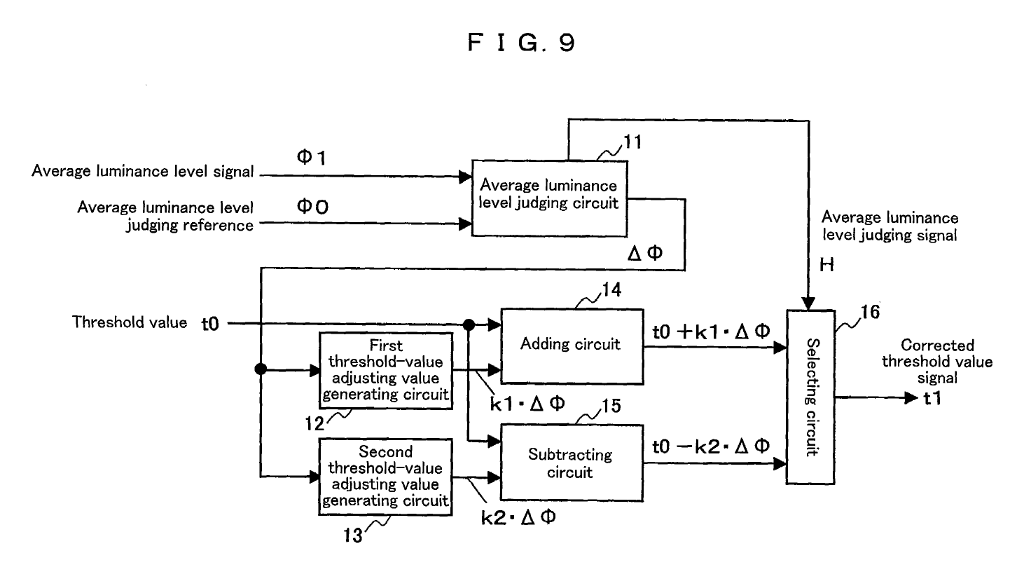

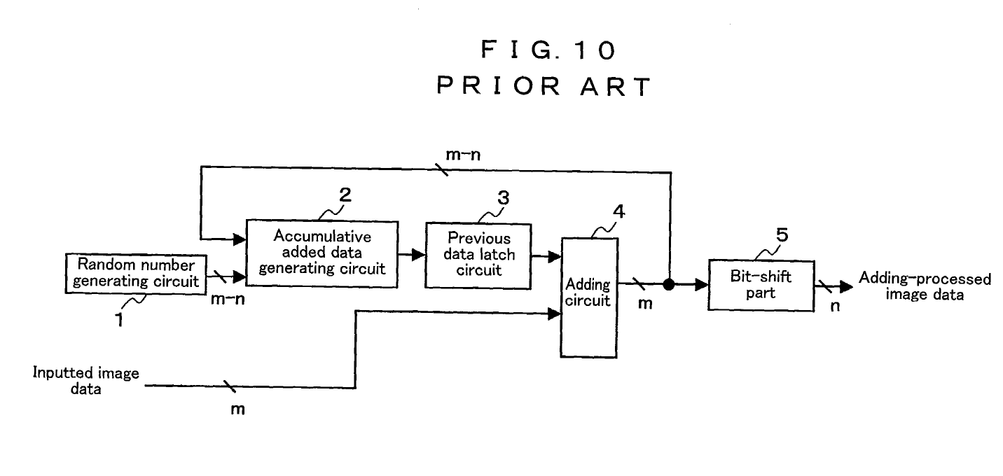

FIG. 9 is a block diagram for showing a structure of a threshold value correcting device according to a sixth embodiment of the present invention. In FIG. 9, reference numeral Φ1 is an average luminance signal of one frame, Φ0 is an average luminance level judging reference that is the reference when judging whether the image of that frame is an image of a high average luminance level (APL) or an image of a low average luminance level, and t0 is a standard threshold value for judging whether or not a boundary between a low-gradation area and a high-gradation area of an image is a contour.

Reference numeral 11 is an average luminance level judging circuit. The average luminance level judging circuit 11 judges, for each frame, whether the current frame is a frame of a high average luminance level or a frame of a low average luminance level based on the average luminance signal Φ1 and the average luminance level judging reference Φ0. Further, the average luminance level judging circuit 11 calculates a luminance difference absolute value ΔΦ between the average luminance level signal Φ1 and the average luminance level judging reference Φ0. Reference numeral 12 is a first threshold-value adjusting value generating circuit. The first threshold-value adjusting value generating circuit 12 generates a threshold-value adjusting value k1·ΔΦ by multiplying an optional gain k1 and the luminance difference absolute value ΔΦ. Reference numeral 13 is a second threshold-value adjusting value generating circuit. The second threshold-value adjusting value generating circuit 13 generates a threshold-value adjusting value k2·ΔΦ by multiplying an optional gain k2 and the luminance difference absolute value ΔΦ. Reference numeral 14 is an adding circuit. The adding circuit 14 adds the threshold-value adjusting value k1·ΔΦ generated by the first threshold-value adjusting value generating circuit 12 to the standard threshold value t0 to generate a threshold value (t0+k1·ΔΦ) that is being shifted to the higher side. Reference numeral 15 is a subtracting circuit. The subtracting circuit 15 subtracts the threshold-value adjusting value k2·ΔΦ generated by the second threshold-value adjusting value generating circuit 13 from the standard threshold value t0 to generate a threshold value (t0−k2·ΔΦ) that is being shifted to the lower side. Reference numeral 16 is a selecting circuit. The selecting circuit 16 selects the threshold value (t0+k1·ΔΦ) that is being shifted to the higher side, which is outputted from the adding circuit 14, when an average luminance level judging signal H outputted from the average luminance level judging circuit 11 indicates that the frame has a high average luminance level. Further, the selecting circuit 16 selects the threshold value (t0−k2·ΔΦ) that is being shifted to the lower side, which is outputted from the subtracting circuit 15, when the average luminance level judging signal H indicates that the frame has a low average luminance level. A signal t1 after the selecting circuit makes the selection is a threshold value that is being corrected according to the average luminance level. This corrected threshold value t1 is used as the threshold values of the first to fifth embodiments or as the base thereof.

Next, operations of the threshold value correcting device according to the embodiment that is structured in the above-described manner will be described. The average luminance level judging circuit 11 judges whether the image of a current frame is a high gradation level image or a low gradation image by comparing the average luminance level signal Φ1 of the current frame with the average luminance level judging reference Φ0. When the average luminance level judging circuit 11 judges that the average luminance level signal Φ1 is equal to the average luminance level judging reference Φ0 or larger, the average luminance level judging circuit 11 outputs an “H” level as an average luminance level judging signal H to the selecting circuit 16. Upon receiving the “H” level of the average luminance level judging signal H, the selecting circuit 16 selects, as a corrected threshold value t1, the threshold value (t0+k1·ΔΦ) obtained by shifting the standard threshold value t0 generated by the adding circuit 14 to a higher side. When the average luminance level judging circuit 11 judges that the average luminance signal Φ1 is less than the average luminance level judging reference Φ0, the average luminance level judging circuit 11 outputs an “L” level as the average luminance level judging signal H to the selecting circuit 16. Upon receiving the “L” level of the average luminance level judging signal H, the selecting circuit 16 selects, as a corrected threshold value t1, the threshold value (t0−k2·ΔΦ) obtained by shifting the standard threshold value t0 generated by the subtracting circuit 15 to a lower side.

To shift the corrected threshold value t1 to the higher side than the standard threshold value t0 means that the accumulative adding processing is promoted in subsequent process, i.e. to suppress cases of not executing the accumulative adding processing. An image of a high average luminance level exhibits low luminous efficiency for human beings. When the accumulative adding processing is promoted, however, the image becomes a visually improved one. By adjusting the gain k1 in the first threshold-value adjusting value generating circuit 12, it becomes possible to perform fine adjustment regarding the shift amount of the corrected threshold value t1 to the higher side.

Inversely, to shift the corrected threshold value t1 to the lower side than the standard threshold value t0 means that the accumulative adding processing is suppressed in subsequent process, i.e. to promote cases of not executing the accumulative adding processing. An image of a low average luminance level exhibits high luminous efficiency for human beings. When the cases of not performing accumulative adding processing are promoted, the image becomes even more visually improved. By adjusting the gain k2 in the second threshold-value adjusting value generating circuit 13, it becomes possible to perform fine adjustment regarding the shift amount of the corrected threshold value t1 to the lower side.

As described above, in this embodiment, the average luminance level within an image frame is determined. Based on the determined level, the threshold value t1 is increased for an image whose average luminance level is high so that the accumulative adding processing is promoted in subsequent process. For an image whose average luminance level is low, the threshold value t1 is decreased so that the accumulative adding processing is not promoted in subsequent process.

The present invention has been described in detail by referring to the most preferred embodiments. However, various combinations and modifications of the components are possible without departing from the spirit and the broad scope of the appended claims.

What is claimed is:

1. An image processing device, comprising:
a noise shaping processing part for performing noise shaping processing on pixel data;
an adding circuit for performing accumulative adding processing on said pixel data to which said noise shaping processing is applied;
a first bit-shift part for performing bit-shift processing on said accumulatively added and noise-shaped pixel data;
a second bit-shift part for performing bit-shift processing on unprocessed pixel data to which said noise shaping processing is not applied;
an inter-pixel subtracting circuit for calculating a gradation level difference between a current pixel and a previous pixel which are neighboring to each other in a horizontal direction in said unprocessed pixel data;
a boundary judging circuit for judging presence of a boundary between a low-gradation area and a high-gradation area in said horizontal direction of said unprocessed pixel data, based on a comparison between said gradation level difference and a prescribed threshold value; and
a selecting circuit which selects an output of said first bit-shift part when said boundary judging circuit judges that there is no boundary, and selects an output of said second bit-shift part when said boundary judging circuit judges that there is a boundary.

2. The image processing device according to claim 1, further comprising a threshold value correcting part which judges whether an average luminance level is high or low for each frame and shifts said prescribed threshold value to a higher side for a frame where said average luminance level is high, while shifting said prescribed threshold value to a lower side for a frame where said average luminance level is low.

3. The image processing device according to claim 2, wherein said threshold value correcting device comprises:
an average luminance level judging circuit which, based on a comparison between an average luminance level of a previous frame and an average luminance level judging reference, judges whether an average luminance level of a current frame is high or low, and calculates a luminance difference absolute value between said average luminance level and said average luminance level judging reference;
a first threshold-value adjusting value generating circuit for generating a first threshold-value adjusting value by multiplying a first gain and said luminance difference absolute value;
a second threshold-value adjusting value generating circuit for generating a second threshold-value adjusting value by multiplying a second gain and said luminance difference absolute value;
an adding circuit for adding said first threshold-value adjusting value to said prescribed threshold value;
a subtracting circuit for subtracting said second threshold-value adjusting value from said prescribed threshold value; and
a selecting circuit which selects an output of said adding circuit when said average luminance level judging circuit judges that said average luminance level of said current frame is high, and selects an output of said subtracting circuit when said average luminance level of said current frame is low.

4. The image processing device according to claim 3, wherein said first threshold-value adjusting value generating circuit and said second threshold-value adjusting value generating circuit optionally change said gains.

5. An image processing device, comprising:
a noise shaping processing part for performing noise shaping processing on pixel data;
an adding circuit for performing accumulative adding processing on said pixel data to which said noise shaping processing is applied;
a first bit-shift part for performing bit-shift processing on said accumulatively added and noise-shaped pixel data;
a second bit-shift part for performing bit-shift processing on unprocessed pixel data to which said noise shaping processing is not applied;
an inter-pixel subtracting circuit for calculating a gradation level difference between a current pixel and a previous pixel which are neighboring to each other in a horizontal direction in said unprocessed pixel data;
a boundary judging circuit for judging presence of a boundary between a low-gradation area and a high-gradation area in said horizontal direction of said unprocessed pixel data, based on a comparison between said gradation level difference and a prescribed threshold value;
a contour judging circuit which, based on a result of judgment made by said boundary judging circuit, calculates a same-gradation continuous pixel number that indicates number of continuous pixels in almost a same gradation level in a horizontal direction of said unprocessed pixel data, and then judges presence of a contour based on a comparison between said same-gradation continuous pixel number and a prescribed contour judging pixel number; and
a selecting circuit which selects an output of said first bit-shift part when said contour judging circuit judges that there is no contour, and selects an output of said second bit-shift part when said boundary judging circuit judges that there is a contour.

6. The image processing device according to claim 5, further comprising a threshold value correcting part which judges whether an average luminance level is high or low for each frame and shifts said prescribed threshold value to a higher side for a frame where said average luminance level is high, while shifting said prescribed threshold value to a lower side for a frame where said average luminance level is low.

7. The image processing device according to claim 6, wherein said threshold value correcting device comprises:
an average luminance level judging circuit which, based on a comparison between an average luminance level of a previous frame and an average luminance level judging reference, judges whether an average luminance level of a current frame is high or low, and calculates a luminance difference absolute value between said average luminance level and said average luminance level judging reference;
a first threshold-value adjusting value generating circuit for generating a first threshold-value adjusting value by multiplying a first gain and said luminance difference absolute value;
a second threshold-value adjusting value generating circuit for generating a second threshold-value adjusting value by multiplying a second gain and said luminance difference absolute value;
an adding circuit for adding said first threshold-value adjusting value to said prescribed threshold value;
a subtracting circuit for subtracting said second threshold-value adjusting value from said prescribed threshold value; and
a selecting circuit which selects an output of said adding circuit when said average luminance level judging circuit judges that said average luminance level of said current frame is high, and selects an output of said subtracting circuit when said average luminance level of said current frame is low.

8. The image processing device according to claim 7, wherein said first threshold-value adjusting value generating circuit and said second threshold-value adjusting value generating circuit optionally change said gains.

9. An image processing device, comprising:
a noise shaping processing part for performing noise shaping processing on pixel data;
an adding circuit for performing accumulative adding processing on said pixel data to which said noise shaping processing is applied;
a first bit-shift part for performing bit-shift processing on said accumulatively added and noise-shaped pixel data;
a second bit-shift part for performing bit-shift processing on unprocessed pixel data to which said noise shaping processing is not applied;
an inter-line subtracting circuit for calculating a gradation level difference between a current pixel and a previous pixel which are neighboring to each other in a vertical direction in said unprocessed pixel data;
a boundary judging circuit for judging presence of a boundary between a low-gradation area and a high-gradation area in said vertical direction of said unprocessed pixel data, based on a comparison between said gradation level difference and a prescribed threshold value; and
a selecting circuit which selects an output of said first bit-shift part when said boundary judging circuit judges that there is no boundary, and selects an output of said second bit-shift part when said boundary judging circuit judges that there is a boundary.

10. The image processing device according to claim 9, further comprising a threshold value correcting part which judges whether an average luminance level is high or low for each frame and shifts said prescribed threshold value to a higher side for a frame where said average luminance level is high, while shifting said prescribed threshold value to a lower side for a frame where said average luminance level is low.

11. The image processing device according to claim 10, wherein said threshold value correcting device comprises:
an average luminance level judging circuit which, based on a comparison between an average luminance level of a previous frame and an average luminance level judging reference, judges whether an average luminance level of a current frame is high or low, and calculates a luminance difference absolute value between said average luminance level and said average luminance level judging reference;
a first threshold-value adjusting value generating circuit for generating a first threshold-value adjusting value by multiplying a first gain and said luminance difference absolute value;
a second threshold-value adjusting value generating circuit for generating a second threshold-value adjusting value by multiplying a second gain and said luminance difference absolute value;
an adding circuit for adding said first threshold-value adjusting value to said prescribed threshold value;
a subtracting circuit for subtracting said second threshold-value adjusting value from said prescribed threshold value; and
a selecting circuit which selects an output of said adding circuit when said average luminance level judging circuit judges that said average luminance level of said current frame is high, and selects an output of said subtracting circuit when said average luminance level of said current frame is low.

12. The image processing device according to claim 11, wherein said first threshold-value adjusting value generating circuit and said second threshold-value adjusting value generating circuit optionally change said gains.

13. An image processing device, comprising:
a noise shaping processing part for performing noise shaping processing on pixel data;
an adding circuit for performing accumulative adding processing on said pixel data to which said noise shaping processing is applied;
a first bit-shift part for performing bit-shift processing on said accumulatively added and noise-shaped pixel data;
a second bit-shift part for performing bit-shift processing on unprocessed pixel data to which said noise shaping processing is not applied;
an inter-line subtracting circuit for calculating a gradation level difference between a current pixel and a previous pixel which are neighboring to each other in a vertical direction in said unprocessed pixel data;
a boundary judging circuit for judging presence of a boundary between a low-gradation area and a high-gradation area in said vertical direction of said unprocessed pixel data, based on a comparison between said gradation level difference and a prescribed threshold value;
a contour judging circuit which, based on a result of judgment made by said boundary judging circuit, calculates a same-gradation continuous pixel number that indicates number of continuous pixels in almost a same gradation level in said vertical direction of said unprocessed pixel data, and then judges presence of a contour based on a comparison between said same-gradation continuous pixel number and a prescribed contour judging pixel number; and
a selecting circuit which selects an output of said first bit-shift part when said contour judging circuit judges that there is no contour, and selects an output of said second bit-shift part when said boundary judging circuit judges that there is a contour.

14. The image processing device according to claim 13, further comprising a threshold value correcting part which judges whether an average luminance level is high or low for each frame and shifts said prescribed threshold value to a higher side for a frame where said average luminance level is high, while shifting said prescribed threshold value to a lower side for a frame where said average luminance level is low.

15. The image processing device according to claim 14, wherein said threshold value correcting device comprises:
an average luminance level judging circuit which, based on a comparison between an average luminance level of a previous frame and an average luminance level judging reference, judges whether an average luminance level of a current frame is high or low, and calculates a luminance difference absolute value between said average luminance level and said average luminance level judging reference;
a first threshold-value adjusting value generating circuit for generating a first threshold-value adjusting value by multiplying a first gain and said luminance difference absolute value;
a second threshold-value adjusting value generating circuit for generating a second threshold-value adjusting value by multiplying a second gain and said luminance difference absolute value;
an adding circuit for adding said first threshold-value adjusting value to said prescribed threshold value;
a subtracting circuit for subtracting said second threshold-value adjusting value from said prescribed threshold value; and
a selecting circuit which selects an output of said adding circuit when said average luminance level judging circuit judges that said average luminance level of said current frame is high, and selects an output of said subtracting circuit when said average luminance level of said current frame is low.

16. The image processing device according to claim 15, wherein said first threshold-value adjusting value generating circuit and said second threshold-value adjusting value generating circuit optionally change said gains.

17. An image processing device, comprising:
a noise shaping processing part for performing noise shaping processing on pixel data;
an adding circuit for performing accumulative adding processing on said pixel data to which said noise shaping processing is applied;
a first bit-shift part for performing bit-shift processing on said accumulatively added and noise-shaped pixel data;
a second bit-shift part for performing bit-shift processing on unprocessed pixel data to which said noise shaping processing is not applied;
an inter-frame subtracting circuit for calculating, for every set of pixels at same coordinates, a gradation level difference between a pixel of a current frame and a pixel of a previous frame which are neighboring to each other in a time base direction in said unprocessed pixel data;
a boundary judging circuit for judging presence of a boundary between a low-gradation area and a high-gradation area in said time base direction of said unprocessed pixel data, based on a comparison between said gradation level difference and a prescribed threshold value; and
a selecting circuit which selects an output of said first bit-shift part when said boundary judging circuit judges that there is no boundary, and selects an output of said second bit-shift part when said boundary judging circuit judges that there is a boundary.

18. The image processing device according to claim 17, further comprising a threshold value correcting part which judges whether an average luminance level is high or low for each frame and shifts said prescribed threshold value to a higher side for a frame where said average luminance level is high, while shifting said prescribed threshold value to a lower side for a frame where said average luminance level is low.

19. The image processing device according to claim 18, wherein said threshold value correcting device comprises:
an average luminance level judging circuit which, based on a comparison between an average luminance level of a previous frame and an average luminance level judging reference, judges whether an average luminance level of a current frame is high or low, and calculates a luminance difference absolute value between said average luminance level and said average luminance level judging reference;
a first threshold-value adjusting value generating circuit for generating a first threshold-value adjusting value by multiplying a first gain and said luminance difference absolute value;
a second threshold-value adjusting value generating circuit for generating a second threshold-value adjusting value by multiplying a second gain and said luminance difference absolute value;
an adding circuit for adding said first threshold-value adjusting value to said prescribed threshold value;
a subtracting circuit for subtracting said second threshold-value adjusting value from said prescribed threshold value; and
a selecting circuit which selects an output of said adding circuit when said average luminance level judging circuit judges that said average luminance level of said current frame is high, and selects an output of said subtracting circuit when said average luminance level of said current frame is low.

20. The image processing device according to claim 19, wherein said first threshold-value adjusting value generating circuit and said second threshold-value adjusting value generating circuit optionally change said gains.
